(19) United States
(12) Patent Application Publication
(10) Pub. No.: US 2021/0405695 A1
(43) Pub. Date: Dec. 30, 2021

(54) CONDITIONAL WINDOWING MODEL FOR FOLDABLE COMPUTING DEVICES

(71) Applicant: MICROSOFT TECHNOLOGY LICENSING, LLC, Redmond, WA (US)

(72) Inventors: Christian KLEIN, Duvall, WA (US); Lauren EDELMEIER, Seattle, WA (US); Ryan PENDLAY, Bellevue, WA (US)

(21) Appl. No.: 17/472,206

(22) Filed: Sep. 10, 2021

Related U.S. Application Data
(62) Division of application No. 16/740,352, filed on Jan. 10, 2020.

(51) Int. Cl. G06F 1/16; G06N 20/00; G06F 3/0488

(52) U.S. Cl. CPC G06F 1/1618; G06N 20/00; G06F 2203/04803; G06F 1/1652; G06F 3/04886; G06F 1/1626

(57) ABSTRACT

A foldable computing device is configured to implement a conditional windowing model. Implementations of the conditional windowing model can provide functionality for stacking application windows when a specified condition, or conditions, is met. The conditional windowing model can also provide a user interface (UI) for facilitating the selection and execution of an application on a second display screen when another application is launched on a first display screen. Implementations of the conditional windowing model can also relocate and/or tile UI elements when a condition, or conditions, are satisfied.

### CROSS-REFERENCE TO RELATED APPLICATION

This application is a divisional of U.S. patent application Ser. No. 16/740,352, filed Jan. 10, 2020, the content of which application is hereby expressly incorporated herein by reference in its entirety.

### BACKGROUND

Foldable computing devices include devices with two screens joined with a hinge or devices with bendable screens. These types of devices can provide benefits over traditional computing devices such as laptop computers. Commonly, however, these devices implement user interface (“UI”) paradigms originally designed for computing devices with traditional form factors. As a result, UIs provided by foldable computing devices can be cumbersome and error-prone, which can lead to incorrect or inadvertent user input and unnecessary consumption of computing resources.

It is with respect to these and other technical challenges that the disclosure made herein is presented.

### SUMMARY

Technologies are disclosed herein for providing a conditional windowing model for foldable computing devices. The disclosed technologies address the technical problems described above by enabling foldable computing devices to provide UIs that are easier to utilize and that result in fewer user input errors. Additionally, the utilization of computing resources by foldable computing devices can be reduced by avoiding the processing associated with inefficient navigation of a UI and inadvertent or incorrect user input. Other technical benefits not specifically mentioned herein can also be realized through implementations of the disclosed subject matter.

### Conditional Window Stacking for Foldable Computing Devices

In one embodiment, a foldable computing device is configured to provide a conditional window stacking model, whereby application windows are stacked when a specified condition, or conditions, is met. Windows are not stacked when the specified condition, or conditions, is not met. For example, and without limitation, windows generated by two applications might be stacked on top of one another when one of the applications launches the other application. In another example, windows generated by applications that are members of a set of applications are stacked.

When application windows are stacked, a window presented by one application is displayed above a window presented by another application. When the topmost window in a stack is closed, minimized, or otherwise dismissed, the window just below is displayed. Window operations initiated on the topmost window in a stack may be performed on all of the windows in the stack. For instance, window operations for moving a window between display regions, spanning a window across display regions, snapping an application window, or minimizing a window, can be simultaneously performed on all of the windows in a stack.

### Application Launch Assistant for Hinged Computing Devices

A foldable computing device that provides multiple display regions can also, or alternately, be configured to provide a UI for facilitating the selection and execution of an application in a second display region when another application is launched in first display region. In particular, a foldable computing device can receive a request to launch a first application in a first display region. For example, and without limitation, a user might select a UI control such as an icon associated with a first application using a taskbar or other type of UI control presented in a first display region provided by a computing device.

In response to receiving the request to launch the first application, the application is launched in the first display region of the foldable computing device. Additionally, a UI which might be referred to herein as the “application launch assistant UI” can be presented in a second display region. The application launch assistant UI includes UI controls that are associated with respective applications. The UI controls might be thumbnail images of currently executing applications, icons, or other types of UI controls. If a user selects one of the UI controls in the application launch assistant UI, the application associated with the selected UI control will be launched in the second display region.

The applications associated with the UI controls in the application launch assistant UI can be selected in various ways. For example, and without limitation, other applications that the first application can launch might be represented by UI controls in the application launch assistant UI. Alternately, the applications associated with the UI controls in the application launch assistant UI might be applications that are currently executing on the hinged computing device or applications that were recently executed on the hinged computing device. The applications represented in the application launch assistant UI might also be manually selected by a user. For instance, a user might specify a set of applications that are to be shown in the application launch assistant UI when a user executes a particular application.

In other embodiments, the applications represented in the application launch assistant UI might be selected using machine learning. For example, machine learning techniques might be utilized to identify applications that are frequently used together. When one of these applications is launched in the first display region, the other applications might be represented by UI controls in the application launch assistant UI shown on the second display region. Other techniques can be utilized to select the application, or applications, that are represented by UI controls in the application launch assistant UI.

### Conditional Relocation of UI Elements

A foldable computing device can also, or alternately, be configured to relocate UI elements when a condition, or conditions, are met. For example, in one embodiment a user might request to launch an application in a first display region provided by a foldable computing device. In response to such a request, the foldable computing device can determine whether UI elements associated with another application, or applications, are displayed in the first display region. The UI elements might, for example, be UI windows, toolbars, or other UI elements displayed by another application. The UI elements might also, or alternately, be UI elements associated with an application that are displayed by an operating system (“OS”) shell, such as an on-screen keyboard or a picture-in-picture (“PIP”) window.

If UI elements are present in the first display region, the foldable computing device can move the UI elements from the first display region to a second display region, typically a display region containing the main application window of the application associated with the UI elements. The foldable computing device can then launch the application in the first display region. In this manner, a newly launched application will not obscure UI elements associated with an already-running application, thereby avoiding potential user confusion in such a situation. This can also prevent user confusion that might be caused if a UI element configured to always remain on top were to be visually associated with a newly launched application in the first display region.

### Conditional Tiling of UI Windows

A foldable computing device can also, or alternately, be configured to tile UI windows when a condition, or conditions, are satisfied. For example, and without limitation, a foldable computing device might execute an application that displays an application window in a first display region. The device might also execute a second application that displays a second application window in a second display region.

A request might also be received to execute a third application in the second display region. In response to receiving such a request, the device can determine whether the first application window and the second application window should be stacked in the first display region. If the foldable computing device determines that the first and second application windows are not to be stacked, it can tile the first application window and the second application window in the first display region such that both application windows are visible. The device can then launch the third application as requested and display an application window generated by the third application in the second display region.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B are device posture diagrams illustrating aspects of the configuration and operation of a hinged computing device that implements the disclosed technologies in one particular configuration;

FIGS. 2A-2C are device posture diagrams illustrating aspects of the configuration and operation of a bendable computing device that implements the disclosed technologies in one particular configuration;

FIGS. 3A-4D are device UI diagrams illustrating aspects of various mechanisms disclosed herein for conditional window stacking;

FIG. 5 is a flow diagram showing aspects of a routine disclosed herein for conditional stacking of application windows, according to one embodiment disclosed herein;

FIGS. 6A-6D are device UI diagrams illustrating aspects of various mechanisms disclosed herein for providing an application launch assistant on a hinged computing device;

FIG. 7 is a flow diagram showing aspects of a routine disclosed herein for providing an application launch assistant on a hinged computing device, according to one embodiment disclosed herein;

FIGS. 8A and 8B are device UI diagrams illustrating aspects of various mechanisms disclosed herein for conditionally relocating UI elements;

FIG. 9 is a flow diagram showing aspects of a routine disclosed herein for conditionally relocating UI elements, according to one embodiment disclosed herein;

FIGS. 10A and 10B are device UI diagrams illustrating aspects of various mechanisms disclosed herein for conditionally tiling UI windows;

FIG. 11 is a flow diagram showing aspects of a routine disclosed herein for conditionally tiling UI windows, according to one embodiment disclosed herein; and

FIG. 12 is a computer architecture diagram showing an illustrative computer hardware and software architecture for a computing device that can implement aspects of the technologies presented herein.

### DETAILED DESCRIPTION

The following detailed description is directed to technologies for providing a conditional windowing model for foldable computing devices. As discussed briefly above, implementations of the disclosed technologies can enable UIs to be provided that are easier to utilize and that result in fewer user input errors. Consequently, the utilization of computing resources can be reduced by avoiding the processing associated with inefficient navigation of a UI and inadvertent or incorrect user input, as compared to previous solutions. Other technical benefits not specifically mentioned herein can also be realized through implementations of the disclosed subject matter.

Those skilled in the art will recognize that the subject matter disclosed herein can be implemented with various types of computing systems and modules, at least some of which are described in detail below. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearables, automobiles, home automation etc.), computing or processing systems embedded in devices (such as wearable computing devices, automobiles, home automation etc.), and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for providing a conditional windowing model for foldable computing devices will be described.

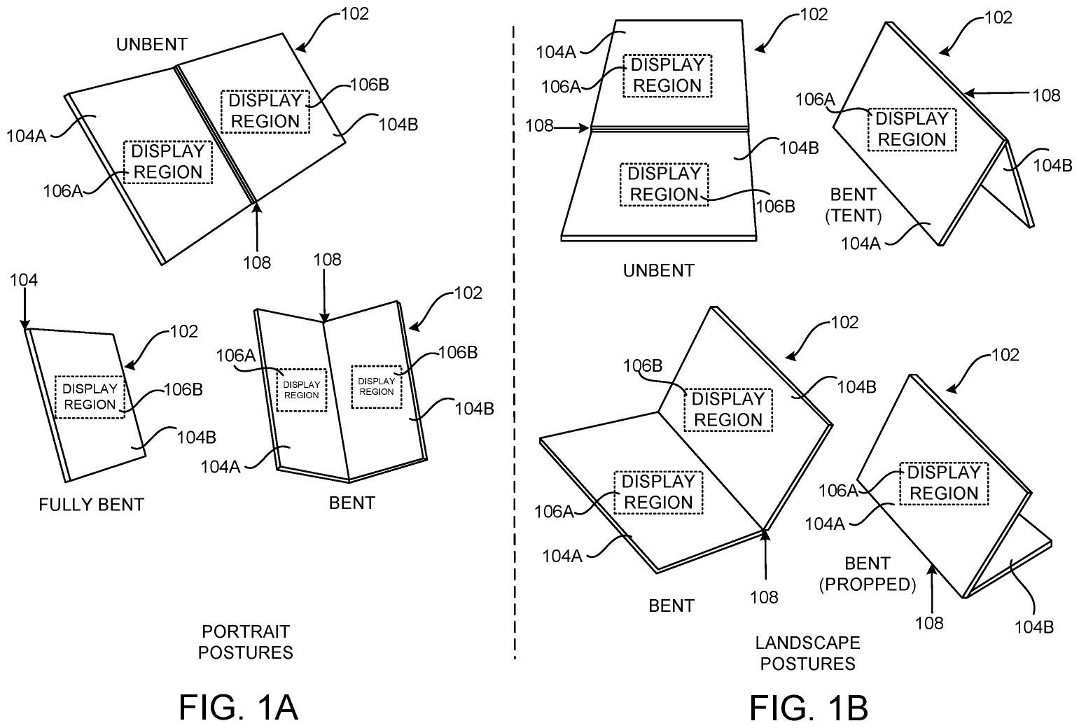

Prior to discussing particular aspects of the disclosed technologies, a brief introduction to foldable computing devices (which might be referred to herein as “foldable devices”) will be provided. As discussed briefly above, foldable devices include multiple screen form factor devices (which might be referred to herein as “hinged devices”) that have two physical display screens joined together with a hinge or other equivalent mechanism. By manipulating the orientation of the display screens with respect to one another by way of the hinge, such devices can be configured in a multitude of postures, some of which are described in greater detail below with regard to FIGS. 1A and 1B.

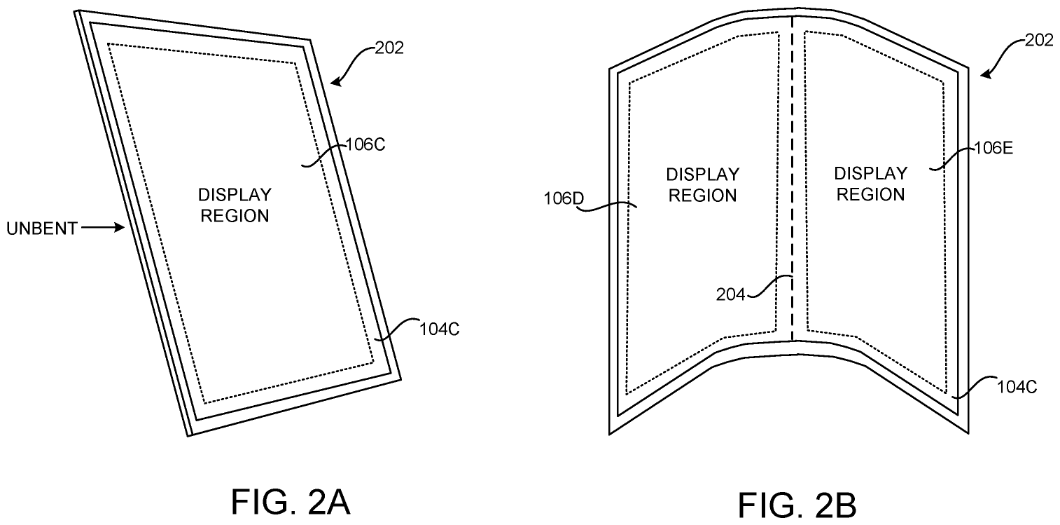

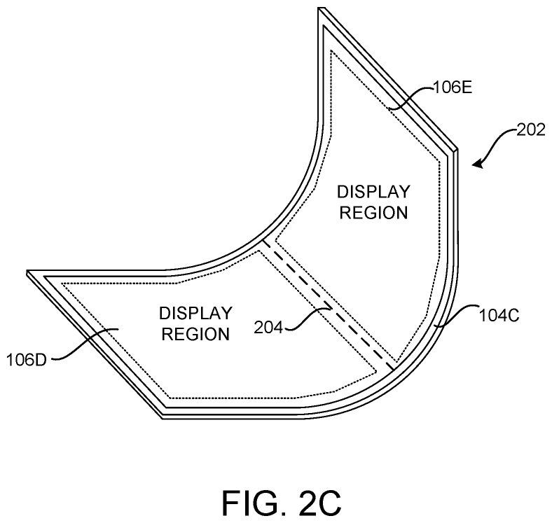

Foldable devices also include computing devices having a bendable display screen (which might be referred to herein as “bendable devices”), such as computing devices utilizing flexible screen technology. When such a device is not bent, it presents a single display surface. When bent, these devices present a single display surface with a crease in the middle. Bendable devices can also be configured in a multitude of postures by varying the amount of bend, some of which are also described in greater detail below with reference to FIGS. 2A-2C.

The display screens of foldable computing devices can be touch sensitive, thereby enabling such devices to recognize touch or stylus input, presses, swipes, and other types of gestures, some of which are described below. These devices can also, of course, be used while being held in various orientations, some of which are described below with regard to FIGS. 1A and 1B.

Referring now to FIGS. 1A and 1B, details regarding several postures for foldable display devices will be described. The examples shown in FIGS. 1A and 1B illustrate some possible postures for a hinged device 102. It is to be appreciated, however, that the illustrated postures generally apply to bendable devices as well.

As shown in FIG. 1A, a hinged device 102 can be configured in multiple postures by varying the angle of the hinge 108 that connects two display devices 104A and 104B (which might be referred to herein as “displays” or “display screens”). In FIG. 1A, for instance, the hinged device 102 is shown in a flat posture where the display screens 104A and 104B are parallel to one another in portrait orientation, a completely open posture where only a single display 104B is visible in portrait orientation, and partially open posture in portrait orientation where the hinge 108 is bent. The hinged device 102 can also be configured in a closed posture (not shown) where neither display screen is visible.

In FIG. 1B, the hinged device 102 is shown in a flat posture where the display screens 104A and 104B are in landscape orientation, in tented and propped postures where the angle of the hinge 108 enables the hinged device 102 to stand on its own and present a single display 104A, and in a partially open posture where one display 104A is flat and the other display 104B is at least partially upright, thereby forming a configuration similar to a traditional laptop computer. In this regard, it is to be appreciated that the postures illustrated in FIGS. 1A and 1B are illustrative and that other postures might also be possible.

As also shown in FIGS. 1A and 1B, the display device 104A provides a first display region 106A that encompasses all or a part of the display 104A. Similarly, the display device 104B provides a second display region 106B that encompasses all or a part of the display 104B. The first display region 106A and the second display region 106B can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form.

Referring now to FIGS. 2A-2C, details will be provided regarding the configuration and operation of a bendable device 202. As mentioned above, a bendable device 202 can also be configured in postures the same as or similar to those described above with regard to FIGS. 1A and 1B. For instance, in the example posture shown in FIG. 2B, the bendable device 202 has been placed in an unbent position, thereby presenting the entirety of the display 104C. The bendable device 202 can also be configured in a closed posture where neither display screen is visible.

In the example posture shown in FIGS. 2B and 2C, the bendable device 202 has been partially bent similar to the partially open posture shown in FIGS. 1A and 1B. In particular, in the example shown in FIG. 2B, the bendable device 202 has been bent while the screen 104C is in a landscape orientation. In the example shown in FIG. 2C, the device 202 has been bent while the screen 104C is in portrait orientation.

When the bendable device 202 is bent, a crease or “fold” 204 is formed in the display 104C. The term “fold” as used herein might refer to the area where a foldable device is folded (i.e. the area of a hinge 108 on a hinged device 102 or the area where the display of a bendable device 202 bends).

As in the case of a hinged device 102, the bendable device 202 can also provide one or more display regions. However, in the case of a bendable device 202, the number of available display regions can vary based upon the posture of the device. For instance, a single display region 106C is provided when the bendable device 202 is in an unbent state as shown in FIG. 2A. Two display regions 106D and 106E can be provided on the display 104C when the bendable device 202 is in a bent posture, such as that shown in FIG. 2B.

It is to be appreciated that certain relative terms (e.g. height, width, top, bottom, left, right) might be utilized herein to describe the configuration of the displays and display regions in the examples presented herein. In this regard, it is to also be appreciated that these terms have been utilized herein for ease of discussion and are not to limit the configuration of the display regions or UI elements. Other terms can be utilized to describe the displays, display regions, UI elements, and their spatial relationships to one another It is also to be appreciated that although generally described separately, the various embodiments described briefly above and in further detail below can be utilized in combination with one another.

### Conditional Window Stacking for Foldable Computing Devices

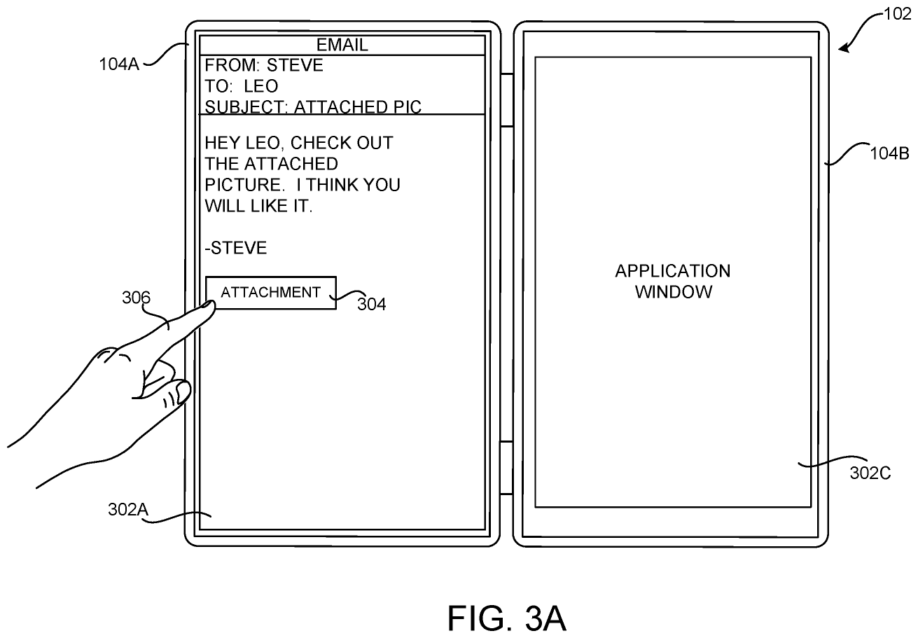

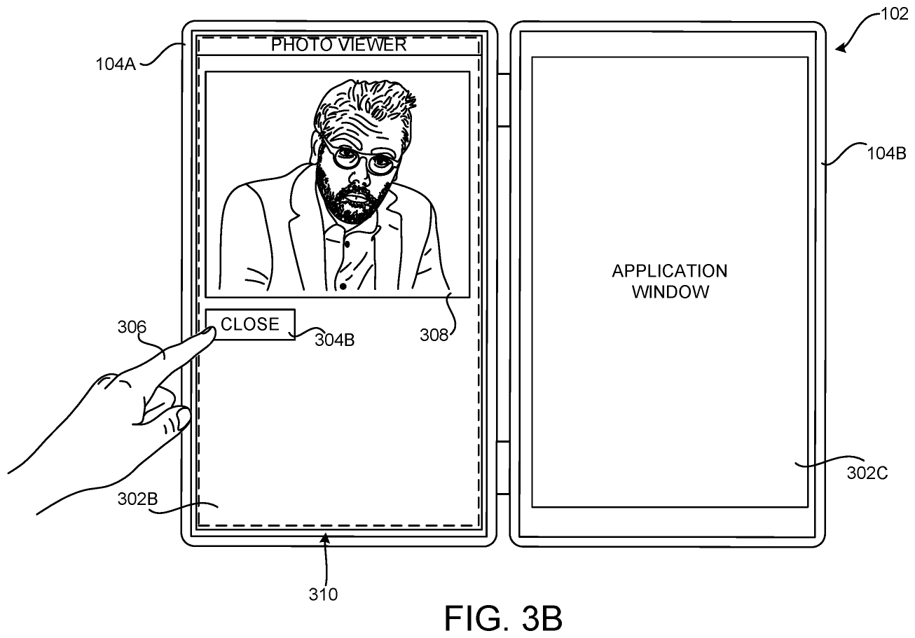

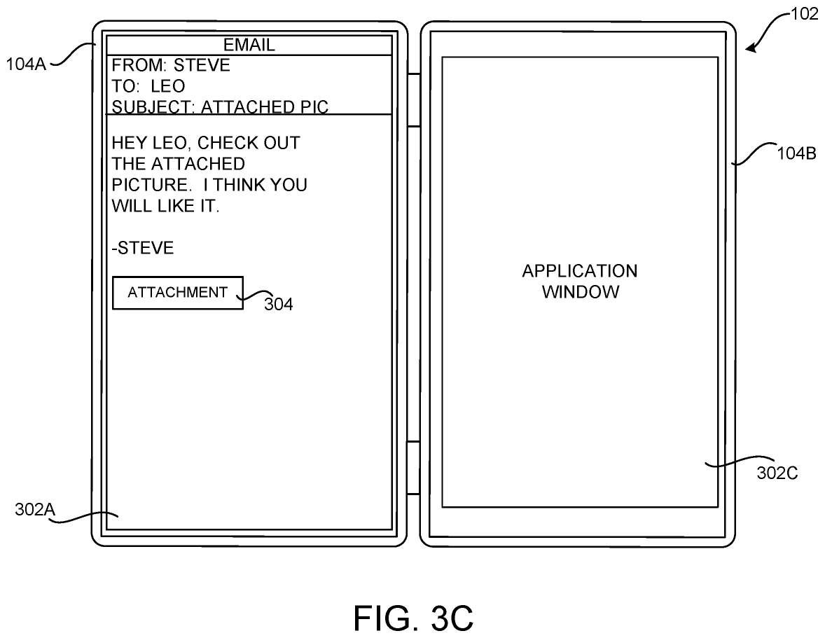

Referring now to FIGS. 3A-3C, details will be provided regarding technologies for conditionally stacking application windows. It is to be appreciated that while the examples shown in FIGS. 3A-3C are made with reference to a hinged device 102, the disclosed aspects are not limited to use with a hinged device 102. Rather, the disclosed technologies can be utilized with other types of foldable devices including bendable devices 202. It is also to be appreciated that while the examples below are presented in the context of a stack of application windows that includes two windows, more windows can be stacked and operated upon in a similar manner.

FIGS. 3A-3C are device UI diagrams illustrating aspects of various mechanisms disclosed herein for providing a conditional window stacking model, whereby application windows are stacked when a specified condition, or conditions, is met. UI windows are not stacked when the specified condition, or conditions, is not met. In the example shown in FIGS. 3A-3C, for instance, application windows 302 (which might be referred to herein as “windows 302” or “UI windows 302”) generated by two applications might be stacked on top of one another when one of the applications launches the other application.

In the example shown in FIGS. 3A-3C, a user has executed a first application, an email client in this case, on the hinged device 102. In turn, the first application has displayed a window 302A for viewing the contents of an email message on the display screen 104A. In this example, the email message being viewed also includes a file attachment and, consequently, the first application has also displayed a UI control 304 in the window 302A for viewing the attachment.

When a user selects the UI control 304, such as through a touch gesture using their finger 306, the first application launches a second application to enable the user to view the attachment to the email message. In the illustrated example, the second application is a photo viewer application for displaying photos.

When the first application (i.e. the email client) launches the second application (i.e. the photo application) in response to the user's request, the second application would typically be launched on the second display screen 104B. However, in this example another application is displaying an application window 302C on the display screen 104B. Consequently, the second application is launched on the display screen 104A and the window 302B displayed by the second application is displayed in a stack 310 that includes the window 302A displayed by the first application. In particular, the window 302B is displayed above the window 302A in z-order, thereby occluding the user's view of the window 302A. This is illustrated in FIG. 3B.

As shown in FIG. 3B, the window 302B generated by the second application includes a view 308 of the photo attached to the email message. The window 302B also completely covers the window 302A. The window 302A is illustrated in FIG. 3B by dashed lines intended to indicate that the window 302A is not visible to the user.

When a request is received to close the topmost window in a stack 310, that window is closed and the window just below the topmost window in the z-order is displayed. For instance, if a user selects the UI control 304B in order to close the window 302B, the window 302B is removed from view, thereby causing the first application window 302A to be displayed. This is illustrated in FIG. 3C. By stacking windows 302 in this manner and presenting the underlying window 302 when a user closes the window at the top of a stack 310, a user is freed from the task of having to relocate the underlying window, which can save computing resources.

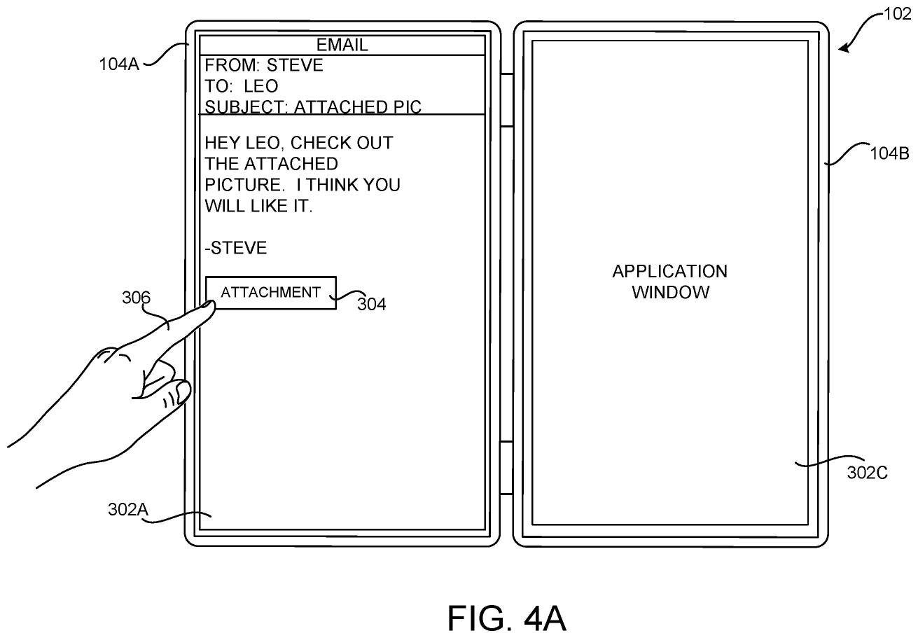

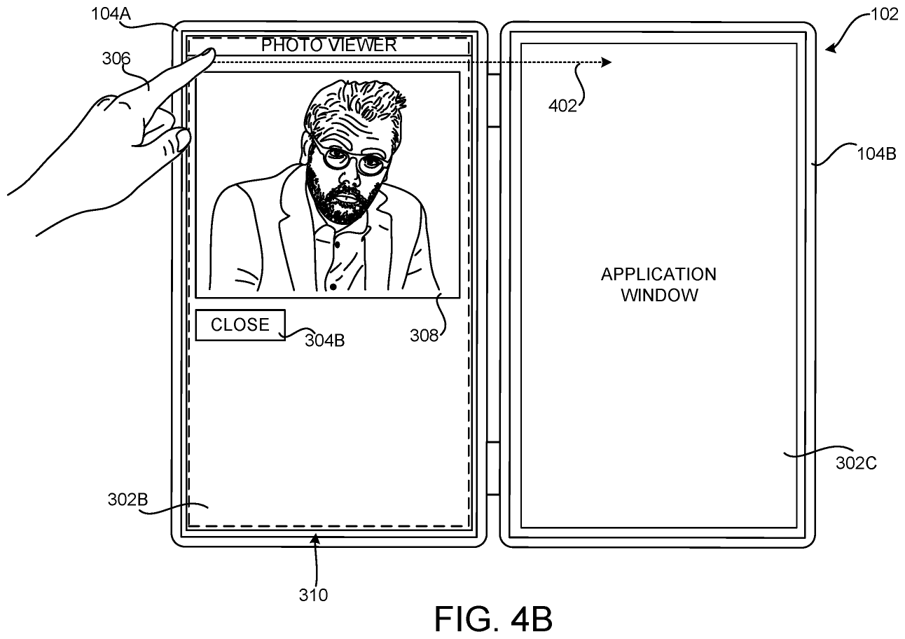

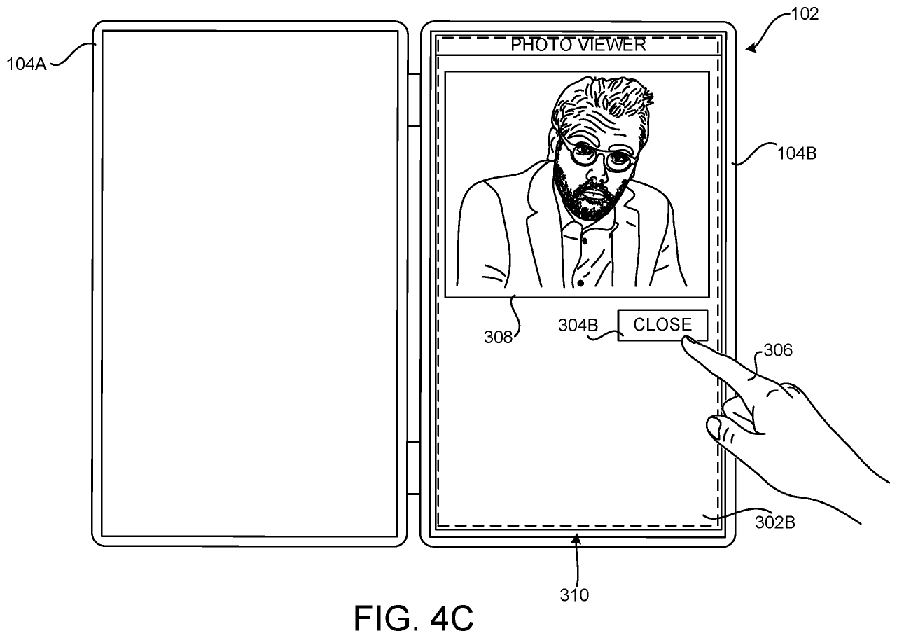

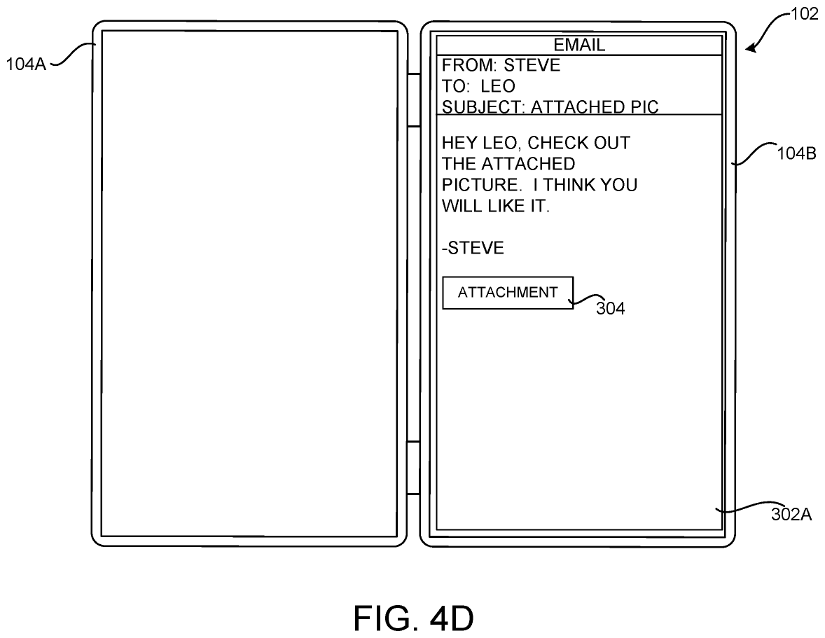

In some embodiments, window operations initiated on the topmost window in a stack 310 are performed on all of the windows in the stack. This is illustrated in FIGS. 4A-4D. As shown in FIG. 4A, a first application, an email client in this example, can show a window 302A for presenting the contents of an email message. As in the example described above, the illustrated email message includes a file attachment and, as a result, the first application has displayed a UI control 304 for previewing the attachment. When a user selects the UI control 304, such as through a touch gesture, a second application is launched and the window 302A is stacked with a window 302B generated by the second application. This is illustrated in FIG. 4B.

A user can then initiate window operations on the topmost window in the stack 310, in this case the window 302B. Window operations initiated on the topmost window 302 in a stack 310 may be performed on all of the windows 302 in the stack 310.

In the example shown in FIG. 4B, for instance, the user has initiated a gesture 402 with their finger 306 to move the window 302B from a display region on the display 104A to a display region on the display 104B of the device 102. In response thereto, the requested window operation is performed on all of the windows in the stack 310, the windows 302A and 302B in this example. As a result, the stack 310, including the windows 302A and 302B, are moved to a display region on the display 104B of the device 102. This is illustrated in FIG. 4C.

Although a window operation for moving a window between display regions has been illustrated in FIGS. 4B and 4C, it is to be appreciated that other types of window operations can be applied to a stack 310 of application windows 302. For example, and without limitation, window operations for spanning an application window 302 across display regions, snapping an application window 302, minimizing an application window 302, or maximizing an application window 302, can be simultaneously performed on all of the windows 302 in a stack 310. Other types of window operations can be performed on a stack 310 in a similar manner.

Continuing this example, a user might select the UI control 304B in order to close the application window 302B. In response thereto, the window 302B is removed (i.e. hidden from view) and the underlying window 302A in the stack 310 is displayed. This is shown in FIG. 4D.

In another example, windows 302 generated by applications that are members of a set of applications are stacked and can be operated upon in the manner described above. Windows 302 generated by application that are not part of the set will not be stacked. A set of applications for which windows 302 are to be stacked might be pre-specified, user-defined, learned, or indicated in another manner. For example, and without limitation, a computing device might utilize machine learning techniques to identify, over time, applications that are a part of the same task flow.

In one specific example, a computing device might learn over time that a user frequently utilizes three applications consecutively or concurrently in a task flow: an image editing application such as ADOBE PHOTOSHOP; a page layout application such as ADOBE INDESIGN; and a Portable Document Format (“PDF”) application such as ADOBE ACROBAT. In this example, the computing device can consider these three applications as part of a set of applications and enable stacking and operation on windows presented by these applications in the manner described above. In this regard, it is to be appreciated that a computing device might also, or alternately, utilize factors other than whether an application is a member of a set when determining whether windows presented by an application are to be stacked with other windows in a stack.

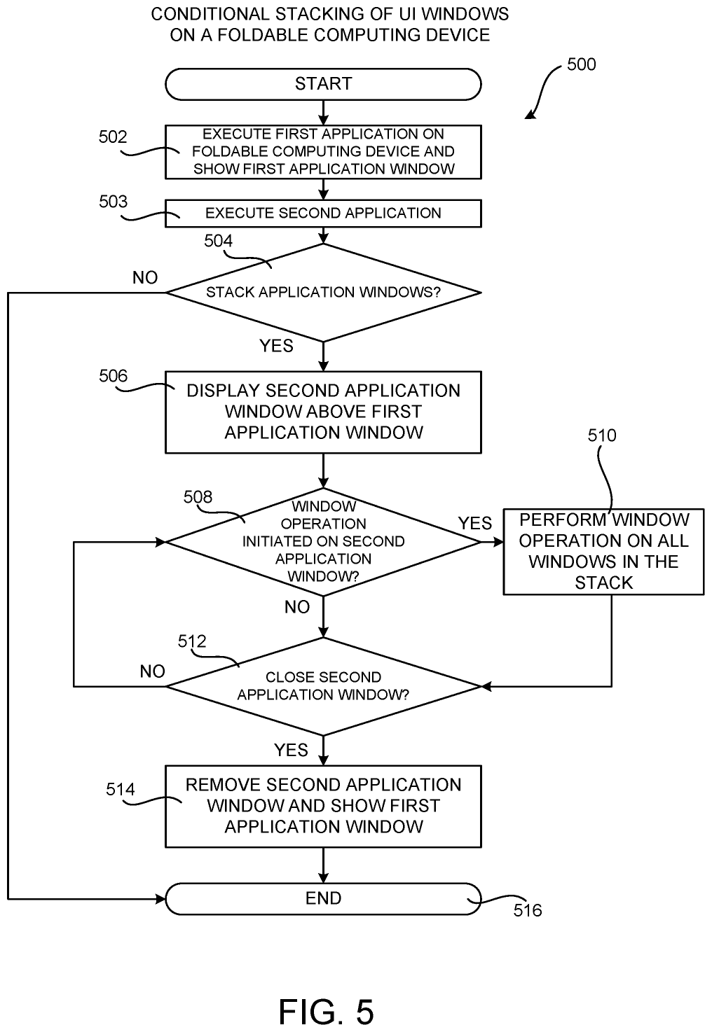

FIG. 5 is a flow diagram showing a routine 500 that illustrates aspects of the operation of a foldable computing device for conditional stacking of application windows 302, according to one embodiment. It should be appreciated that the logical operations described herein with regard to FIG. 5, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 500 begins at operation 502, where a first application executes on a foldable computing device and presents a first application window 302A. The routine 500 then proceeds from operation 502 to operation 503, where a second application is executed on the foldable computing device. The routine 500 then proceeds from operation 503 to operation 504, where the device determines if application windows of the first application are to be stacked with application windows of the second application. For instance, and as discussed above, the device might determine whether the first and second applications are members of a set of applications for which application windows are to be stacked. Other mechanisms can be utilized in other embodiments to determine whether windows generated by different applications are to be stacked.

If windows of the first and second application windows are not to be stacked, an application window generated by the second application might be presented on a display screen or in a display region other than the screen or region containing the first application window. If, however, windows of the first and second application are to be stacked, the routine 500 proceeds from operation 504 to operation 506, where the foldable computing device displays the application window 302B displayed by the second application above the first application window 302A in z-order. As discussed above, the application window 302A and the application window 302B together form a stack 310 of application windows.

From operation 506, the routine 500 proceeds to operation 508, where the foldable computing device determines if a window operation has been performed on the second application window 302B (i.e. the window 302B on top of the stack 310). As discussed above, window operations include, but are not limited to, operations for moving an application window 302 between display regions, spanning an application window 302 across display regions, pinning an application window, saving a window state for use in resuming the window state in the future, snapping an application window 302, minimizing an application window 302, and maximizing an application window 302. Other types of window operations can be performed on a stack 310 in a similar manner.

If a window operation has been initiated on the second application window 302B, the routine 500 proceeds from operation 508 to operation 510, where the window operation is performed on all of the windows 302 in the stack 310. The routine 500 then proceeds from operation 510 to operation 512.

At operation 512, the foldable computing device determines if a request has been received to close the second application window 302B. If such a request has been received, the routine 500 proceeds from operation 512 to operation 514, where the foldable computing device hides or closes the second application window 302B and displays the first application window 302A. The routine 500 then proceeds from operation 514 to operation 516, where it ends.

### Application Launch Assistant for Hinged Computing Devices

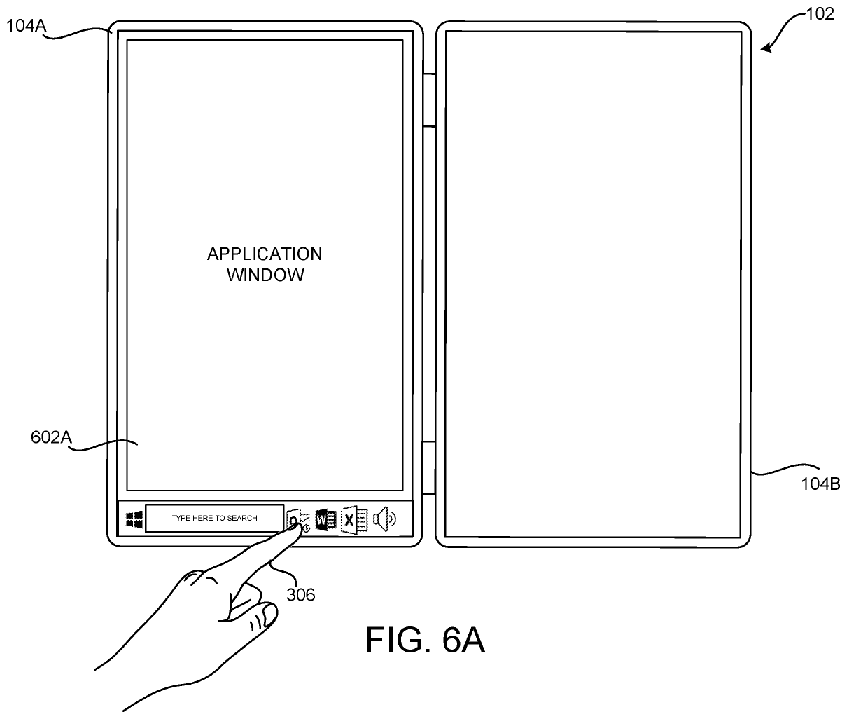

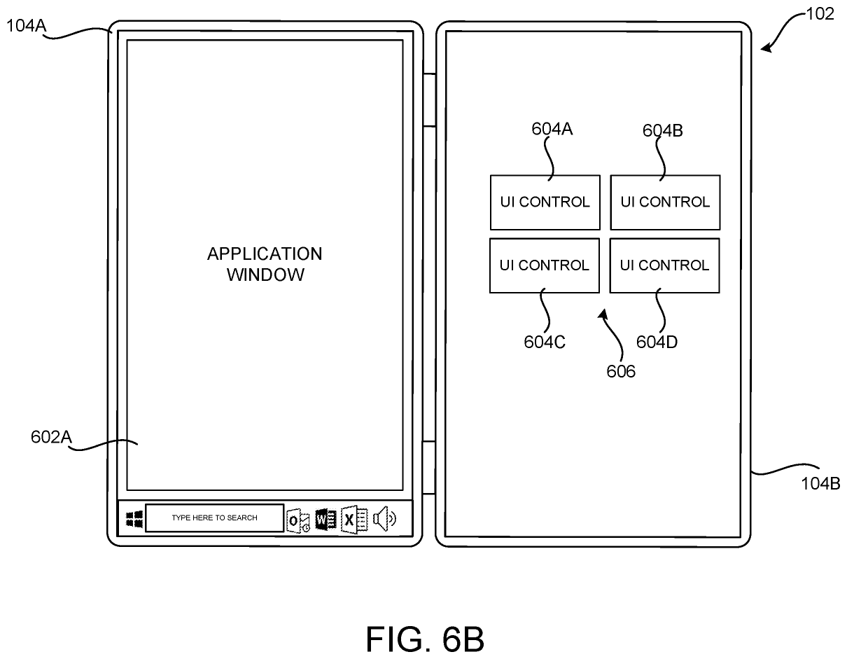

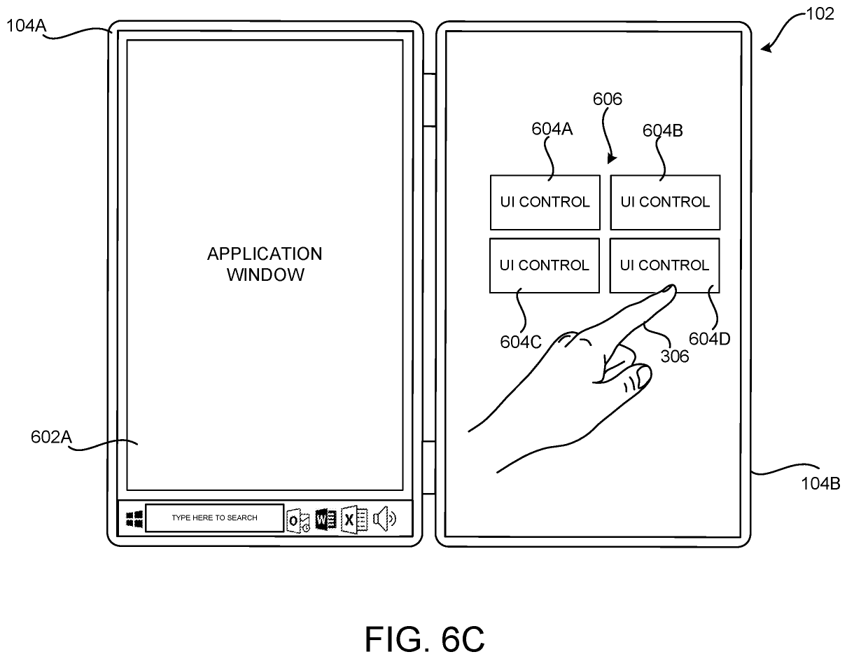

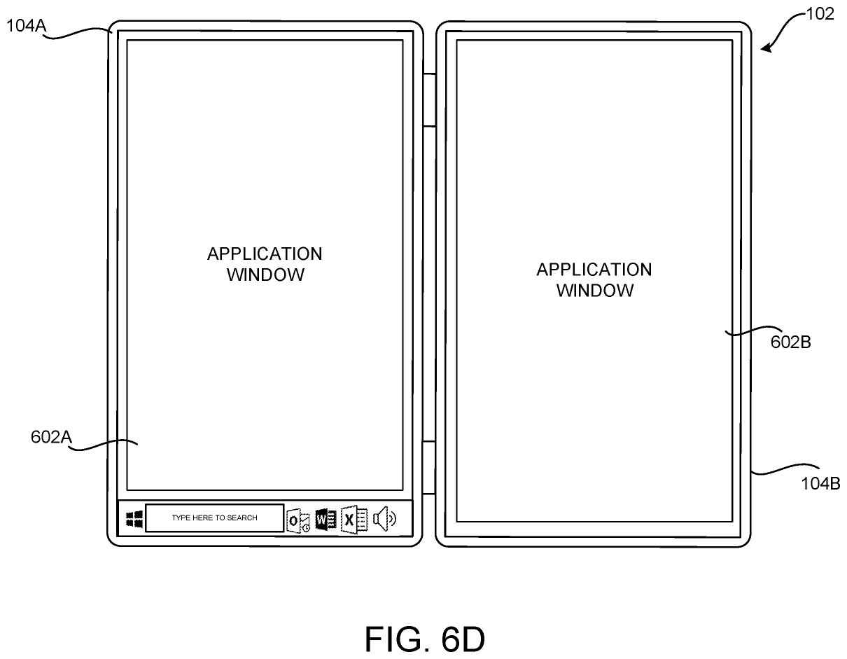

Referring now to FIGS. 6A-6D, technologies for providing an application launch assistant UI on a foldable computing device will be provided. As discussed briefly above, a foldable computing device can also be configured to provide a UI for facilitating the selection and execution of an application on a second display screen 104B or display region 106B when another application is launched on a first display screen 104B or display region 106A. In the example shown in FIG. 6A, for instance, a hinged computing device 102 can receive a request to launch a first application on a first display screen 104A. For example, and without limitation, a user might utilize their finger 306 select a UI control such as an icon associated with a first application using a taskbar or other type of UI control presented on the first display screen 104A of a hinged computing device 102.

In response to receiving the request to launch the first application, the application is launched on the first display screen 104A of the hinged computing device 102 and an application window 602A associated with the launched application is shown on the display screen 104A. Additionally, and as shown in FIG. 6B, a UI 606, which might be referred to herein as the “application launch assistant UI 606,” can be presented on the second display screen 104B. The application launch assistant UI 606 can be displayed and utilized in a similar manner in display regions 106 presented on bendable computing devices 202.

In one embodiment, the application launch assistant UI 606 includes UI controls 604A-604D that are associated with respective applications. The UI controls 604 might be thumbnail images of currently executing applications, icons, or other types of UI controls. If a user selects one of the UI controls 604 in the application launch assistant UI 606, the application associated with the selected UI control 604 will be launched on the second display screen 104B. In the example shown in FIG. 6C, for instance, a user has selected the UI control 604D. In response thereto, the application associated with the UI control 604D has been launched and that application presents an application window on the display screen 104B. This is illustrated in FIG. 6D.

The applications associated with the UI controls 604 in the application launch assistant UI 606 can be chosen in various ways. For example, and without limitation, other applications that the first launched application can launch might be represented in the application launch assistant UI 606. Alternately, the applications associated with the UI controls 604 in the application launch assistant UI might be applications that are currently executing on the hinged computing device or applications that were recently executed (e.g. executed within a previous period of time) on the hinged computing device 102.

The applications represented by UI controls 604 in the application launch assistant UI 606 might also, or alternately, be manually selected by a user. For instance, a user might specify a set of applications that are to be shown in the application launch assistant UI 606 when a user executes a particular application. The applications represented by UI controls 604 in the application launch assistant UI 606 might also be user-specified “favorite” applications, applications pinned by a user to a task bar or start menu, or applications that have been manually selected in another way.

In other embodiments, the applications represented in the application launch assistant UI 606 might be selected by the device 102 using various techniques including, but not limited to, machine learning. For example, machine learning techniques might be utilized to identify applications that are frequently used together or part of the same task flow (e.g. a word processing application and an illustration application). When one of these applications is launched on the first display screen 104A, the other applications might be represented by UI controls 604 in the application launch assistant UI 606 shown on the second display screen 104B. Other techniques can be utilized to select the application, or applications, that are represented by UI controls 604 in the application launch assistant UI 606.

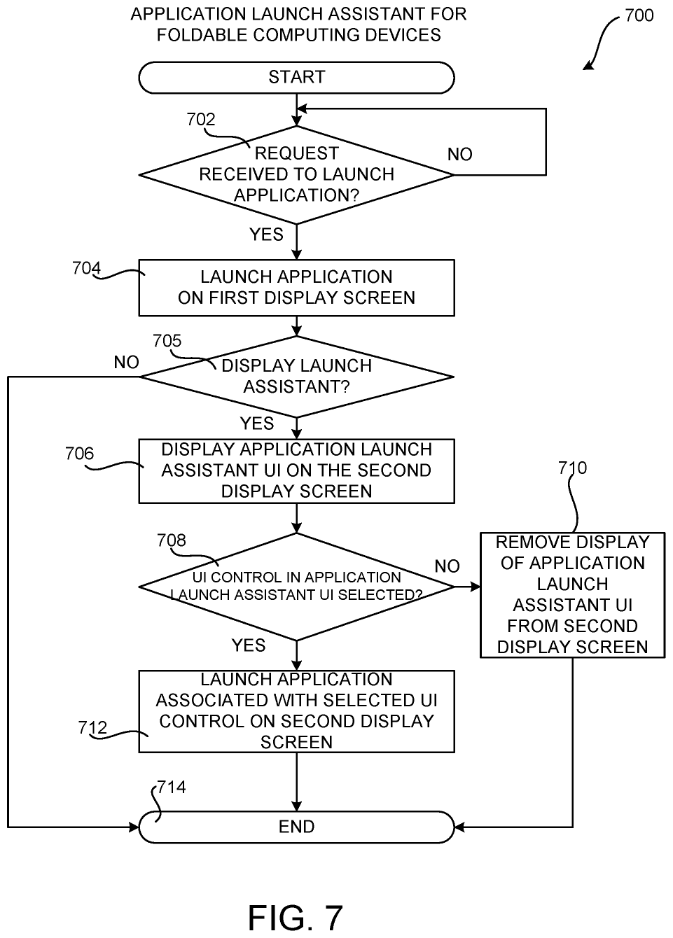

FIG. 7 is a flow diagram showing a routine 700 that illustrates aspects of the operation of a hinged computing device 102 for providing an application launch assistant UI 606, according to one embodiment. As discussed above, although the illustrated example presents the application launch assistant UI 606 on a display screen of a hinged computing device 102, a similar process can be utilized to provide the application launch assistant UI 606 in a display region 106 presented by a bendable computing device 202.

The routine 700 begins at operation 702, where a hinged computing device 102 receives a request to launch an application. As discussed above, such a request might be received in the form of a selection of an icon associated with the application located in a task bar or in another manner. Other techniques can be utilized to initiate the launching of an application in other embodiments.

If a request is received to launch an application, the routine 700 proceeds from operation 702 to operation 704, where the application is launched on the first display screen 104A of the hinged computing device. The routine 700 then proceeds from operation 704 to operation 705, where the hinged computing device 102 determines if the application launch assistant UI 606 is to be displayed. In some embodiments, for example, the application launch assistant UI 606 will not be presented if the display screen 104 or region 106 in which the UI 606 is to be displayed is occupied with UI from another program. The application launch assistant UI 606 might not be displayed under other conditions in other embodiments.

If the application launch assistant UI 606 is not to be displayed, the routine 700 proceeds from operation 705 to operation 714, where it ends. If the application launch assistant UI 606 is to be displayed, the routine 700 proceeds to operation 706, where the application launch assistant UI 606 is presented on the second display screen 104B of the hinged computing device. As discussed above, the application launch assistant UI 606 includes UI controls 604 associated with other applications. The applications represented by the UI controls 604 can be selected in various ways, some of which were described above.

From operation 706, the routine 700 proceeds to operation 708, where the hinged computing device 708 determines if a selection has been made of one the UI controls 604 in the application launch assistant UI 606. If such a selection has been made, the routine 700 proceeds from operation 708 to operation 712, where the hinged computing device 102 launches the application associated with the selected UI control 604 on the second display screen 104B. If a selection is not made of a UI control 604 in the application launch assistant UI 606 (e.g. a user makes a selection outside the UI 606), the routine 700 proceeds from operation 708 to operation 710, where the UI 606 is removed from the second display screen 104B. From operations 710 and 712, the routine 700 proceeds to operation 714, where it ends.

### Conditional Relocation of UI Elements

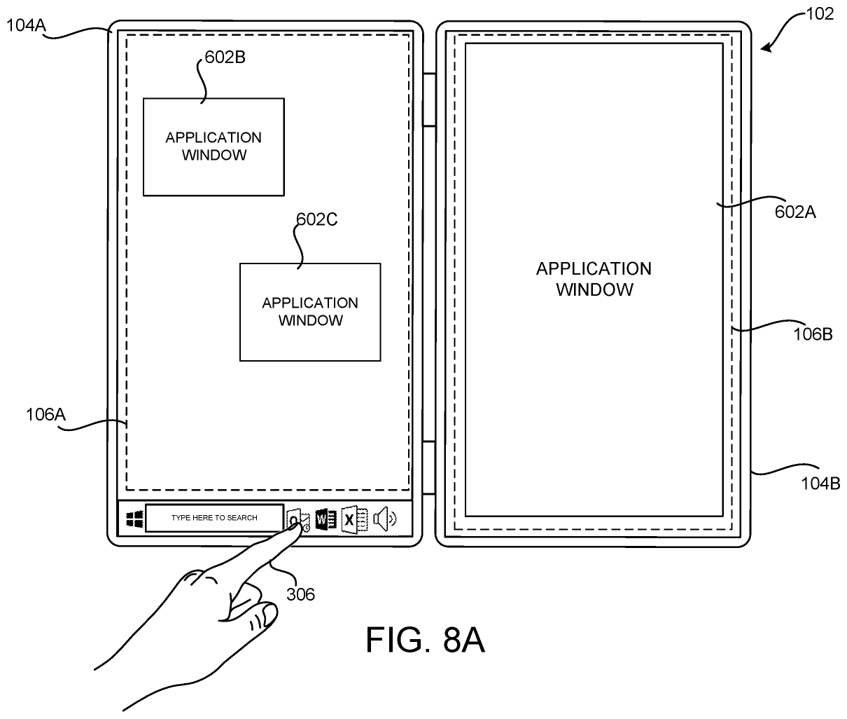

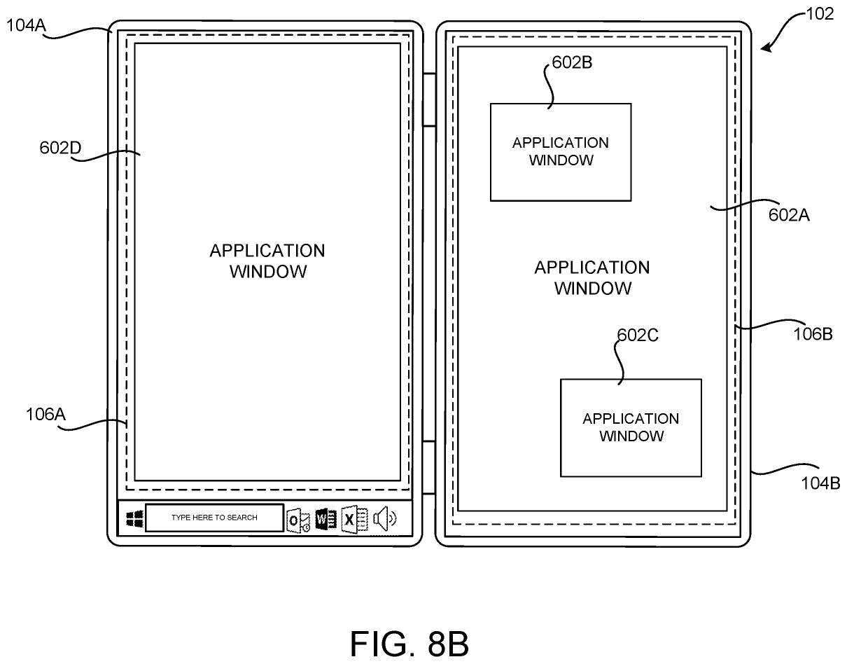

Referring now to FIGS. 8A and 8B, one mechanism disclosed herein for conditionally relocating UI elements will be described. As discussed briefly above, a foldable computing device can also, or alternately, be configured to relocate certain UI elements when a condition, or conditions, are met. In the example shown in FIG. 8A, for instance, an application is presenting an application window 602A in a display region 106B on a display screen 104B provided by a hinged computing device 102. The same application is also displaying application windows 602B and 602C in the display region 106A on the other display screen 104A. The application windows 602B and 602C can be thought of as “floating” since they are displayed separately from the main application window 602A.

In the example shown in FIG. 8A, a user has also requested to launch another application in the display region 106A through the selection of an icon in a taskbar using their finger 306. In response to receiving the request to launch the application in the display region 106A, the hinged computing device 102 can determine whether UI elements associated with another application, or applications, are displayed in the display region 106A in which the application is to be launched.

If UI elements are present in display region 106A in which the application is to be launched, the device 102 can move the UI elements from the display region 106A to another display region 106B, typically a display region 106 containing main application window of the application associated with the UI elements. In the example shown in FIGS. 8A and 8B, for instance, the device 102 relocates the application windows 602B and 602C to the display region 106B containing the application window 602A. This is shown in FIG. 8B.

Once the UI elements have been relocated in the manner described above, the device 102 can launch the requested application in the display region 106A. In this manner, a newly launched application will not obscure UI elements associated with an already-running application, thereby avoiding potential user confusion in such a situation.

It is to be appreciated that although application windows 602B and 602C have been relocated in the example shown in FIGS. 8A and 8B, other types of UI elements can be relocated in a similar manner in other embodiments. For example, and without limitation, the UI elements might be other types of UI windows, toolbars, or other UI elements displayed by an application. The UI elements might also, or alternately, be UI elements associated with an application that are displayed by an operating system (OS) shell, such as an on-screen keyboard or a picture-in-picture (“PIP”) window. Other types of UI elements not specifically described herein can be relocated in a similar manner.

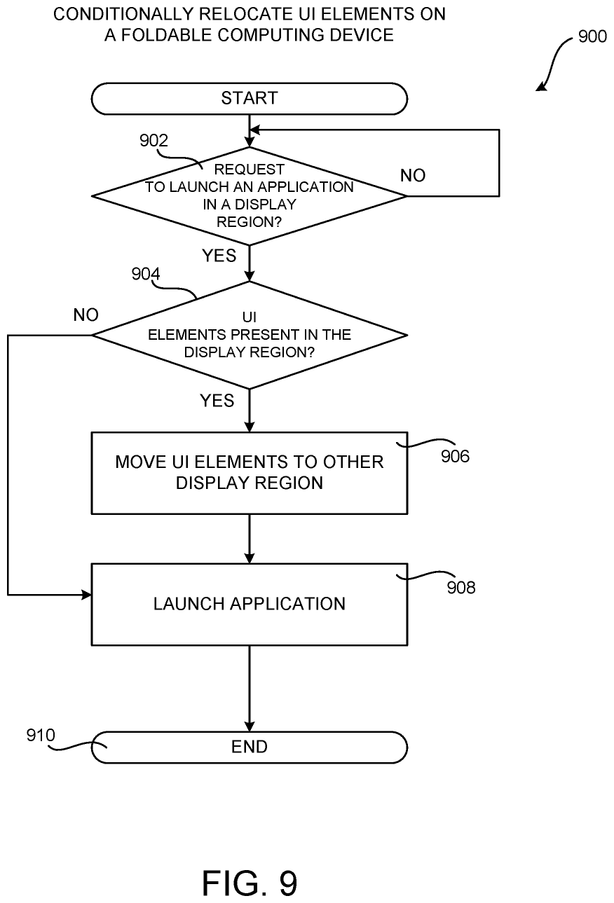

FIG. 9 is a flow diagram showing aspects of a routine 900 disclosed herein for conditionally relocating UI elements, according to one embodiment disclosed herein. The routine 900 begins at operation 902, where a foldable computing device receives a request to launch an application in a display region 106. For instance, a user might select an icon or other type of UI element in a taskbar or in another location in order to initiate the launching of an application.

If a request to launch an application is received, the routine 900 proceeds from operation 902 to 904, where the foldable computing device determines whether UI elements are present in the display region 106 in which the application is to be launched. If UI elements are present in the display region 106, the routine 900 proceeds from operation 904 to operation 906, where the foldable computing device moves the already present UI elements from the display region 106 in which the application is to be launched to another display region. As discussed above, for example, the UI elements might be moved to a display region 106 containing the main application window for an application associated with the UI elements.

Once the UI elements have been moved, the routine 900 proceeds from operation 906 to operation 908, where the foldable computing device launches the application as requested at operation 902. The routine 900 then proceeds from operation 908 to operation 910, where it ends.

### Conditional Tiling of UI Windows

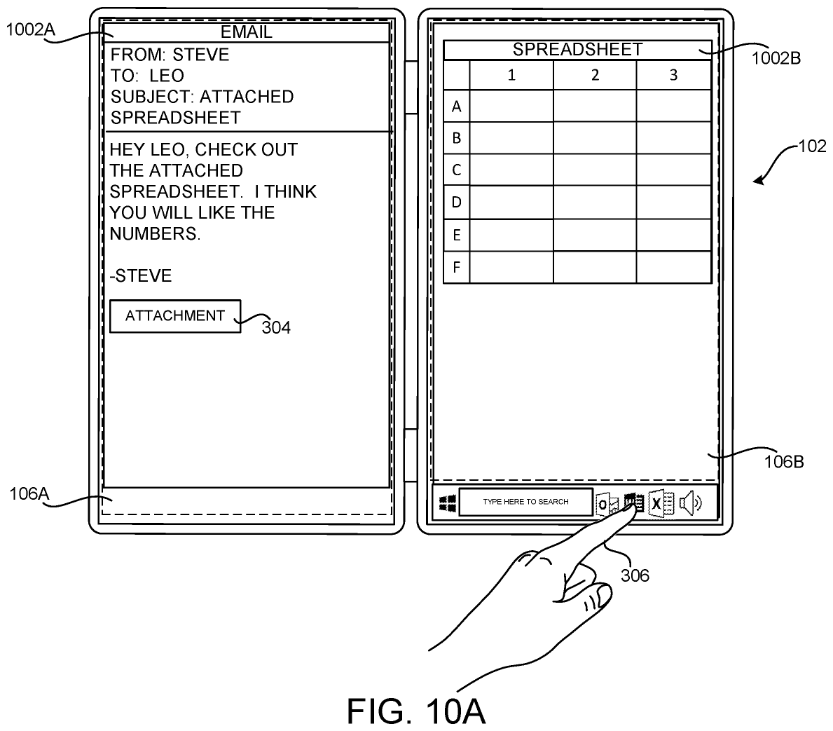

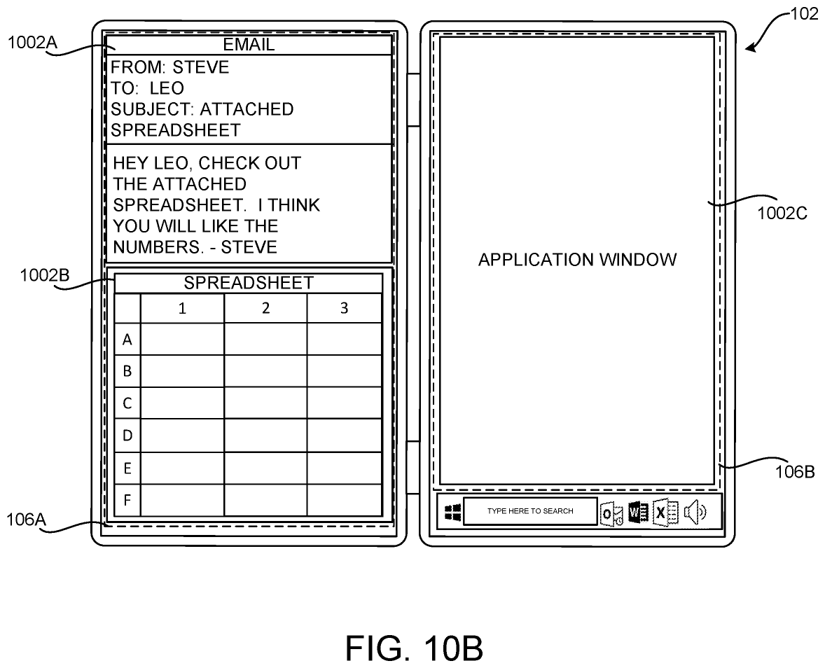

FIGS. 10A and 10B are device UI diagrams illustrating aspects of various mechanisms disclosed herein for conditionally tiling UI windows. As discussed briefly above, a foldable computing device can also, or alternately, be configured to tile UI windows when a condition, or conditions, are satisfied. For example, and as shown in FIG. 10A, a hinged computing device 102 might execute a first application that displays an application window 1002A in a first display region 106A. The device 102 might also execute a second application that displays a second application window 1002B in a second display region 106B. In the illustrated example, the first display region 106A is located on a first display screen and the second display region 106B is located on a second display screen.

The device 102 might also receive a request to execute a third application in the second display region 106B. For instance, in the illustrated example, a user has utilized their finger 306 to select an icon shown in a taskbar in order to launch the application associated with the icon. In response to receiving such a request, the device 102 can determine whether the first application window 1002A and the second application window 1002B should be stacked in the first display region 106B.

As in the examples described above, the windows 1002A and 1002B can be stacked when a specified condition, or conditions, is not met. For example, and without limitation, the windows 1002A and 1002B generated by two applications might be stacked on top of one another when one of the applications is capable of launching the other application. In another example, windows 1002A and 1002B generated by applications that are members of a set of applications are stacked. Other conditions under which application 1002A and 1002B are stacked are described above.

If the device 102 determines that the first application window 1002A and the second application window 1002B are to be stacked, the device 102 stacks the windows 1002A and 1002B in the display region 106A in the manner described above. If, however, the device 102 determines that the first and second application windows 1002A and 1002B are not to be stacked (e.g. one or more of the conditions described above are not satisfied), the device 102 can tile the first application window 1002A and the second application window 1002B in the first display region 106A such that both application windows 1002A and 1002B are visible. This is illustrated in FIG. 10B.

Once the windows 1002A and 1002B have been stacked or tiled, the device 102 can launch the application in the second display region 106B. The application window 1002C generated by the application can then be displayed in the display region 106B as shown in FIG. 10B.

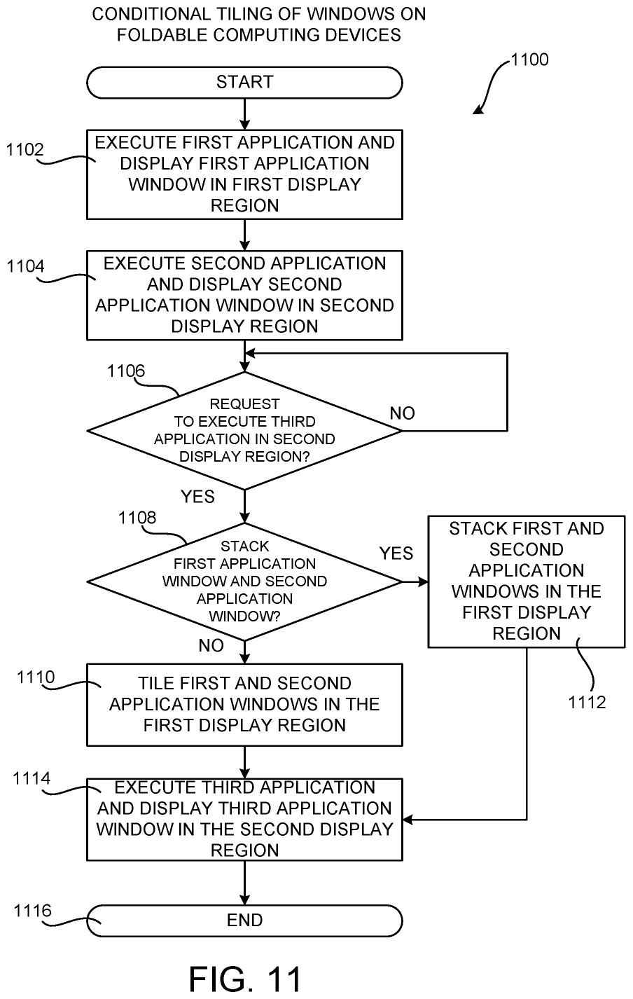

FIG. 11 is a flow diagram showing aspects of a routine 1100 disclosed herein for conditionally tiling UI windows, according to one embodiment disclosed herein. The routine 1100 begins at operation 1102, where a foldable computing device executes a first application that displays a first application window in a first display region 106A. The routing 1100 then proceeds from operation 1102 to operation 1104, where the device executes a second application that displays a second application window in a second display region 106B. The routine 1100 then proceeds from operation 1102 to operation 1104.

At operation 1104, the foldable computing device determines if a request to execute a third application in the second display region 106B has been received. If so, the routine 1100 proceeds from operation 1106 to operation 1108, where the foldable computing device will determine if the application window generated by the first application and the application window generated by the second application are to be stacked in the first display region 106A. If so, the routine 1100 proceeds from operation 1108 to operation 1112, where the first and second application windows are stacked in the first display region 106A in the manner described above.

If the foldable computing device determines that the application windows are not to be stacked, the routine 1100 proceeds from operation 1108 to operation 1110, where the foldable computing device tiles the first and second application windows in the first display region 106A in the manner described above with regard to FIGS. 10A and 10B. The routine 1100 then proceeds from operations 1110 and 1112 to operation 1114, where the third application is launched as requested. The newly launched application, in turn, displays its application window in the second display region 106B. The routine 1100 then proceeds from operation 1114 to operation 1116, where it ends.

In some embodiments, the various windowing states described above can be previewed to a user while the user is in the middle of a window manipulation gesture. In this way, the results of the conditional windowing behavior described herein can be made apparent to users while they are performing windowing gestures. Embodiments disclosed herein can also prevent snapping of windows when there is no other application window open or visible.

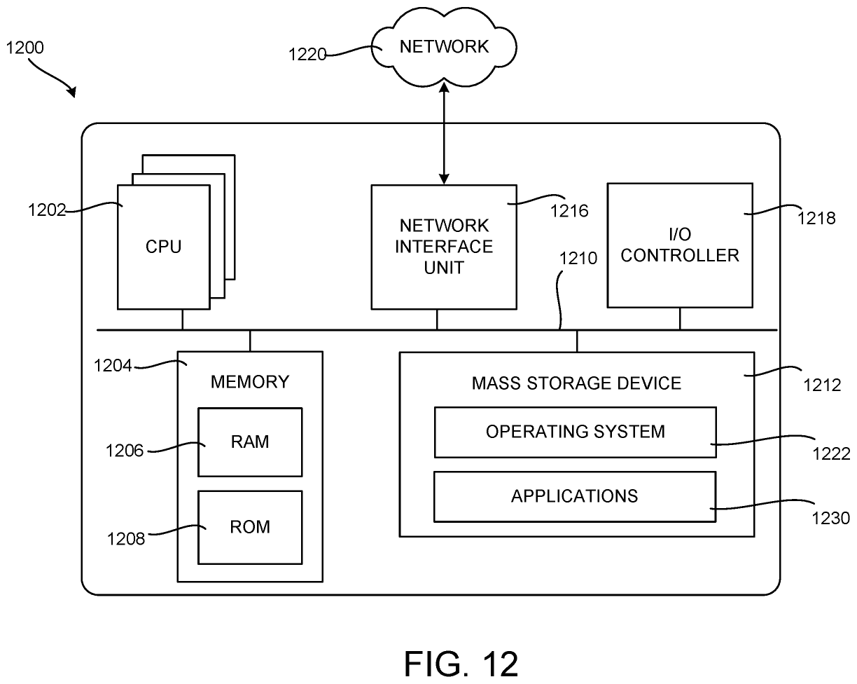

FIG. 12 is a computer architecture diagram showing an illustrative computer hardware and software architecture for a computing device that can implement the various technologies presented herein. In particular, the architecture illustrated in FIG. 12 can be utilized to implement a foldable device, such as the hinged devices 102 and bendable devices 202 described herein. The illustrated architecture can also be utilized to implement other types of computing systems.

The computer 1200 illustrated in FIG. 12 includes a central processing unit 1202 (“CPU”), a system memory 1204, including a random-access memory 1206 (“RAM”) and a read-only memory (“ROM”) 1208, and a system bus 1210 that couples the memory 1204 to the CPU 1202. A basic input/output system (“BIOS” or “firmware”) containing the basic routines that help to transfer information between elements within the computer 1200, such as during startup, can be stored in the ROM 1208. The computer 1200 further includes a mass storage device 1212 for storing an operating system 1222, application programs 1230 such as those described above with regard to FIGS. 1A-11, and other types of programs. The functionality described above is implemented by one or more of these programs in various configurations. The mass storage device 1212 can also be configured to store other types of programs and data.

The mass storage device 1212 is connected to the CPU 1202 through a mass storage controller (not shown) connected to the bus 1210. The mass storage device 1212 and its associated computer readable media provide non-volatile storage for the computer 1200. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 1200.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 1200. For purposes of the claims, the phrase “computer storage medium,” and variations thereof, does not include waves or signals per se or communication media.

According to various configurations, the computer 1200 can operate in a networked environment using logical connections to remote computers through a network such as the network 1220. The computer 1200 can connect to the network 1220 through a network interface unit 1216 connected to the bus 1210. It should be appreciated that the network interface unit 1216 can also be utilized to connect to other types of networks and remote computer systems. The computer 1200 can also include an input/output controller 1218 for receiving and processing input from a number of other devices, including a keyboard, mouse, touch input, a digital pen, or a physical sensor such as cameras and biometric sensors.

The computer 1200 can also be configured with a suitable video output device that can provide output to one or more display screens, such as those described above. One or more of the displays can be a touch-sensitive display that is configured to detect the presence and location of a touch. Such a display can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen is incorporated on top of a display as a transparent layer to enable a user to use one or more touches to interact with objects or other information presented on the display.

A touch-sensitive display can be configured to detect discrete touches, single touch gestures, and/or multi-touch gestures. These are collectively referred to herein as “gestures” for convenience. Several gestures will now be described. It should be understood that these gestures are illustrative and are not intended to limit the scope of the appended claims.

In some configurations, the computer 1200 supports a tap gesture in which a user taps a display once. A double tap gesture in which a user taps a display twice can also be supported. The double tap gesture can be used for various reasons including, but not limited to, zooming in or zooming out in stages. In some configurations, the computer 1200 supports a tap and hold gesture in which a user taps and maintains contact for at least a pre-defined time. The tap and hold gesture can be used for various reasons including, but not limited to, opening a context-specific menu.

In some configurations, the computer 1200 supports a pan gesture in which a user places a finger on a display and maintains contact with display while moving their finger. The pan gesture can be used for various reasons including, but not limited to, moving through screens, images, or menus at a controlled rate. Multiple finger pan gestures are also contemplated.

In some configurations, the computer 1200 supports a flick gesture in which a user swipes a finger in the direction the user wants the screen to move. The flick gesture can be used for various reasons including, but not limited to, scrolling horizontally or vertically through menus or pages. In some configurations, the computer 1200 supports a pinch and stretch gesture in which a user makes a pinching motion with two fingers (e.g., thumb and forefinger) or moves the two fingers apart. The pinch and stretch gesture can be used for various reasons including, but not limited to, zooming gradually in or out of a web site, map, or picture.

Although the gestures described above have been presented with reference to the use of one or more fingers for performing the gestures, other appendages such as digital pens can be used to interact with the computing device 1200. As such, the above gestures should be understood as being illustrative and should not be construed as being limiting in any way.

It should be appreciated that the software components described herein, when loaded into the CPU 1202 and executed, can transform the CPU 1202 and the overall computer 1200 from a general-purpose computing device into a special-purpose computing device customized to facilitate the functionality presented herein. The CPU 1202 can be constructed from any number of transistors or other discrete circuit elements, which can individually or collectively assume any number of states. More specifically, the CPU 1202 can operate as a finite-state machine, in response to executable instructions contained within the software modules disclosed herein. These computer-executable instructions can transform the CPU 1202 by specifying how the CPU 1202 transitions between states, thereby transforming the transistors or other discrete hardware elements constituting the CPU 1202.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 1200 in order to store and execute the software components presented herein. It also should be appreciated that the architecture shown in FIG. 12 for the computer 1200, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 1200 might not include all of the components shown in FIG. 12, can include other components that are not explicitly shown in FIG. 12, or can utilize an architecture completely different than that shown in FIG. 12.

It should be appreciated that the computing architecture shown in FIG. 12 has been simplified for ease of discussion. It should also be appreciated that the illustrated computing architecture can include and utilize many more computing components, devices, software programs, networking devices, and other components not specifically described herein.

The disclosure presented herein also encompasses the subject matter set forth in the following clauses:

Clause 1. A computer-implemented method, comprising: executing a first application on a foldable computing device, the first application configured to display a first application window; determining that the first application has launched a second application, the second application configured to display a second application window; and responsive to determining that the first application has launched the second application, displaying the first application window and the second application window in a stack, whereby the second application window is displayed above the first application window.

Clause 2. The computer-implemented method of clause 1, further comprising: determining that a window operation has been initiated on the second application window; and responsive to determining that the window operation has been initiated on the second application window, performing the window operation on the windows in the stack.

Clause 3. The computer-implemented method of any of clauses 1 or 2, wherein the window operation comprises an operation for moving the second application window from a first display region to a second display region.

Clause 4. The computer-implemented method of any of clauses 1-3, wherein the window operation comprises an operation which, when performed, will cause the second application window to span a first display region and a second display region.

Clause 5. The computer-implemented method of any of clauses 1-4, wherein the window operation comprises an operation for snapping the second application window within a display region.

Clause 6. The computer-implemented method of any of clauses 1-5, wherein the window operation comprises an operation for minimizing the second application window.

Clause 7. The computer-implemented method of any of clauses 1-6, further comprising: receiving a request to close the second application window; and responsive to receiving the request to close the second application window, removing the second application window from view and displaying the first application window.

Clause 8. A computer-implemented method, comprising: receiving a request to launch a first application in a first display region of a foldable computing device; and responsive to receiving the request to launch the first application, launching the first application in the first display region, displaying a user interface (UI) in a second display region of the foldable computing device, the UI comprising a plurality of UI controls, each of the UI controls associated with a respective application, receiving a selection of one of the UI controls, and responsive to receiving the selection of the one of the UI controls, launching an application associated with the selected UI control in the second display region.

Clause 9. The computer-implemented method of clause 8, wherein the first application is configured to launch the applications associated with the UI controls.

Clause 10. The computer-implemented method of any of clauses 8 or 9, wherein the applications associated with the UI controls comprise applications recently executed on the foldable computing device.

Clause 11. The computer-implemented method of any of clauses 8-10, wherein the applications associated with the UI controls comprise applications currently executing on the foldable computing device.

Clause 12. The computer-implemented method of any of clauses 8-11, wherein the applications associated with the UI controls comprise a set of applications selected by a user or the foldable computing device.

Clause 13. The computer-implemented method of any of clauses 8-12, wherein the applications associated with the UI controls are selected using machine learning.

Clause 14. A computer-implemented method, comprising: receiving a request to launch an application in a first display region provided by a foldable computing device; and responsive to receiving the request to launch the first application in the first display region, determining whether one or more user interface (UI) elements associated with a second application are present in the first display region, moving the one or more UI elements from the first display region to a second display region provided by the foldable computing device responsive to determining the one or more UI elements associated with the second application are present in the first display region, and launching the application in the first display region.

Clause 15. The computer-implemented method of clause 14, wherein the one or more UI elements comprise UI elements displayed by the application.

Clause 16. The computer-implemented method of any of clauses 14 or 15, wherein the one or more UI elements comprise UI elements displayed by an operating system.

Clause 17. The computer-implemented method of any of clauses 14-16, wherein the foldable computing device comprises a hinged computing device having a first display screen and a second display screen, wherein the first display region is located on the first display screen, and wherein the second display region is located on the second display screen.

Clause 18. A computer-implemented method, comprising: executing a first application on a foldable computing device, the first application configured to display a first application window in a first display region; executing a second application on the foldable computing device, the second application configured to display a second application window in a second display region; receiving a request to launch a third application on the foldable computing device in the second display region, the third application configured to display a third application window; and responsive to receiving the request, determining if the first application window and the second application window should be stacked, responsive to determining that the first application window and the second application window should not be stacked, tiling the first application window and the second application window in the first display region, and launching the third application and displaying the third application window in the second display region.

Clause 19. The computer-implemented method of clause 18, further comprising displaying the first application window and the second application window in a stack in the first display region responsive to determining that the first application window and the second application window should be stacked.

Clause 20. The computer-implemented method of any of clauses 18 or 19, wherein the foldable computing device comprises a hinged computing device having a first display screen and a second display screen, wherein the first display region is located on the first display screen, and wherein the second display region is located on the second display screen.

Based on the foregoing, it should be appreciated that technologies for providing a conditional windowing model for foldable computing devices have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method, comprising:
receiving a request to launch a first application in a first display region of a foldable computing device;
launching, by at least one processing unit and based at least in part on the request, the first application in the first display region;
displaying a user interface (UI) in a second display region of the foldable computing device, the UI comprising a plurality of UI controls, wherein the plurality of UI controls is respectively associated with a plurality of second applications;
receiving a selection of one of the plurality of UI controls; and
launching, in the second display region, a second application, of the plurality of second applications, that is associated with the one of the plurality of UI controls selected.

2. The computer-implemented method of claim 1, wherein the first application is configured to launch the plurality of second applications.

3. The computer-implemented method of claim 1, wherein the plurality of second applications comprises most recently executed applications.

4. The computer-implemented method of claim 1, wherein the plurality of second applications comprises currently executing applications.

5. The computer-implemented method of claim 1, wherein the plurality of second applications comprises a set of applications selected by a user of the foldable computing device.

6. The computer-implemented method of claim 1, wherein the plurality of second applications are identified using machine learning.

7. The computer-implemented method of claim 1, wherein each of the plurality of second applications and the first application are part of a same task flow.

8. A computing system comprising:
at least one processing unit; and
a computer-readable medium having encoded thereon computer-executable instructions to cause the at least one processing unit to:
receiving a request to launch a first application in a first display region of a foldable computing device;
launching, based at least in part on the request, the first application in the first display region;
displaying a user interface (UI) in a second display region of the foldable computing device, the UI comprising a plurality of UI controls, wherein the plurality of UI controls is respectively associated with a plurality of second applications;
receiving a selection of one of the plurality of UI controls; and
launching, in the second display region, a second application, of the plurality of second applications, that is associated with the one of the plurality of UI controls selected.

9. The computing system of claim 8, wherein the first application is configured to launch the plurality of second applications.

10. The computing system of claim 8, wherein the plurality of second applications comprises most recently executed applications.

11. The computing system of claim 8, wherein the plurality of second applications comprises currently executing applications.

12. The computing system of claim 8, wherein the plurality of second applications comprises a set of applications selected by a user of the foldable computing device.

13. The computing system of claim 8, wherein the plurality of second applications are identified using machine learning.

14. The computing system of claim 8, wherein each of the plurality of second applications and the first application are part of a same task flow.

15. A computer-implemented method, comprising:
executing a first application on a foldable computing device, the first application configured to display a first application window;
determining that the first application and a second application are part of a task flow that utilizes a plurality of applications consecutively to execute one or more operations on a common object, wherein the task flow is identified using machine learning;
in response to determining that the first application and the second application are part of the task flow, displaying a UI control that represents the second application in the first application window;
receiving a user input selecting the UI control displayed in the first application window; and
in response to receiving the user input, launching the second application, the launched second application configured to display a second application window.

16. The computer-implemented method of claim 15, further comprising:
displaying the first application window and the second application window in a stack, whereby the second application window is displayed at least in part above the first application window;
receiving a user input for executing a window operation on the second application window; and
performing the window operation on the first application window and the second application window in the stack based on the user input.

17. The computer-implemented method of claim 16, wherein the window operation moves the stack from a first display region of the foldable computing device to a second display region of the foldable computing device.

18. The computer-implemented method of claim 15, wherein the task flow comprises applications having a common publisher.

19. The computer-implemented method of claim 15, wherein the task flow comprises a user-defined set of applications.

20. The computer-implemented method of claim 15, further comprising:
determining that a plurality of applications are part of the task flow; and
in response to determining that the plurality of applications are part of the task flow, displaying a plurality of UI controls, respectively associated with the plurality of applications, in the first application window.
